(19) United States
(12) Patent Application Publication
(10) Pub. No.: US 2025/0363569 A1
(43) Pub. Date: Nov. 27, 2025

(54) DETERMINING EFFECTS OF ARTIFICIAL INTELLIGENCE OUTPUTS ON SOCIAL NETWORKS

(71) Applicant: INTERNATIONAL BUSINESS MACHINES CORPORATION, ARMONK, NY (US)

(72) Inventors: Andrew T. Penrose, Castleknock (IE); Elezaveta Koumpan, Perth Road (CA); Jeremy Ray Fox, Georgetown, TX (US); Jonathan D. Dunne, Dungarvan (IE)

(21) Appl. No.: 18/815,910

(22) Filed: Aug. 27, 2024

(30) Foreign Application Priority Data
May 22, 2024 (GB) 2407283.7

(51) Int. Cl. G06Q 50/00; G06N 5/022; G06N 7/01

(52) U.S. Cl. CPC G06Q 50/01; G06N 5/022; G06N 7/01

(57) ABSTRACT

A computer-implemented method for determining effects of artificial intelligence model outputs on a social network. The method includes generating related target features of an artificial intelligence model, and simulating outputs of the artificial intelligence model using model layer results. The method may also analyze metadata of actors of the social network. The method may use latent class analysis of the related target features, the simulated outputs, and the metadata of the social network actors to categorize predicted effects of outputs of the artificial intelligence model on actors of the social network based on a joint probability distribution between classes of the metadata of the actor and context classes of the target features of the outputs. The method may output categories of the predicted effects of the outputs on the social network actors.

### BACKGROUND

The present invention relates to artificial intelligence effect analysis, and more specifically, to determining effects of artificial intelligence outputs on social networks.

The advent of sophisticated artificial intelligence (AI) systems has introduced new challenges in predicting and understanding the long-term consequences of their deployment. While highly efficient, these systems often interact with complex social and collaborative networks in ways that lead to unforeseen impacts. This unpredictability is a growing concern across various industries, particularly those relying heavily on AI for decision-making.

Social environments are very dynamic, and AI's impact might change rapidly, making it hard to create stable predictive models. Organizations and societies need to prepare for the cascading effects that AI-driven decisions can have.

### SUMMARY

According to an aspect of the present invention there is provided a computer-implemented method for determining effects of artificial intelligence model outputs on a social network, said method comprising: generating related target features of an artificial intelligence model; simulating outputs of the artificial intelligence model using model layer results; analyzing metadata of actors of the social network; using latent class analysis of the related target features, the simulated outputs, and the metadata of the social network actors to categorize predicted effects of outputs of the artificial intelligence model on actors of the social network based on a joint probability distribution between classes of the metadata of the actor and context classes of the target features of the outputs; and outputting categories of the predicted effects of the outputs on the social network actors.

The method has the advantage of providing an indication of predicted impacts of an artificial intelligence output such as a prediction or decision actors in a social network (including collaborative networks) based on the metadata of the actors. This provides a prediction of impacts on the social network that may have further consequences.

According to another aspect of the present invention there is provided a computer system for determining effects of artificial intelligence model outputs on a social network comprising: a processor, a memory device coupled to the processor, and a computer readable storage device coupled to the processor, wherein the storage device contains program code executable by the processor via the memory device to implement a method comprising: generating related target features of an artificial intelligence model; simulating outputs of the artificial intelligence model using model layer results; analyzing metadata of actors of the social network; using latent class analysis of the related target features, the simulated outputs, and the metadata of the social network actors to categorize a predicted effect of outputs of the artificial intelligence model on actors of the social network based on a joint probability distribution between classes of the metadata of the actor and context classes of the target features of the outputs; and outputting categories of the predicted effect of the outputs on the social network actors.

According to a further aspect of the present invention there is provided a computer program product for determining effects of artificial intelligence model outputs on a social network, the computer program product comprising a computer readable storage medium having program instructions embodied therewith, the program instructions executable by a processor to cause the processor to: generate related target features of an artificial intelligence model; simulate outputs of the artificial intelligence model using model layer results; analyze metadata of actors of the social network; use latent class analysis of the related target features, the simulated outputs, and the metadata of the social network actors to categorize a predicted effect of outputs of the artificial intelligence model on actors of the social network based on a joint probability distribution between classes of the metadata of the actor and context classes of the target features of the outputs; and output categories of the predicted effect of the outputs on the social network actors.

The computer readable storage medium may be a non-transitory computer readable storage medium and the computer readable program code may be executable by a processing circuit.

### BRIEF DESCRIPTION OF THE DRAWINGS

Embodiments of the present invention will now be described, by way of example only, with reference to the accompanying drawings:

FIG. 1 is a flow diagram of an example embodiment of an aspect of a method in accordance with embodiments of the present disclosure;

FIG. 2 is a flow diagram of an example embodiment of another aspect of a method in accordance with embodiments of the present disclosure;

FIG. 3A is a schematic diagram of an example embodiment of an artificial intelligence model as used in the present disclosure;

FIG. 3B is a schematic diagram of an example embodiment of a social network as used in the present disclosure;

FIG. 3C is a schematic diagram of an example embodiment of a social knowledge graph as output in the present disclosure;

FIG. 4 is a block diagram of an example embodiment of a system in accordance with embodiments of the present invention; and

FIG. 5 is a block diagram of an example embodiment of a computing environment for the execution of at least some of the computer code involved in performing the present invention.

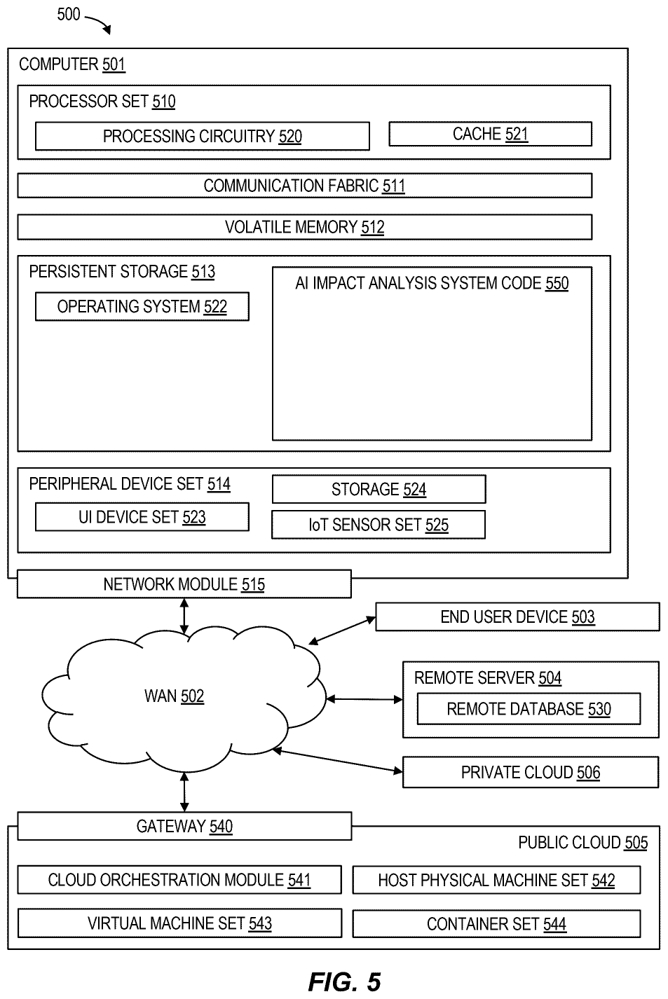

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for modeling potential effects of artificial intelligence (AI) outputs on social networks. The described method determines if an AI output will impact a social group class type in a social network.

The term “social network” is defined as including social networks for personal, professional, or entertainment purposes, and including social collaboration for working to achieve a common goal. The social network may include actors in the form of individuals, groups, organizations, societies, etc.

The described method and system use a combination of latent class analysis and knowledge graph theory to provide an AI impact prediction component to determine the impact of AI results on collaborative or social structures.

AI model data is analyzed in association with a social network. The AI model data may include model features and layer output results and the method uses diverse high quality social network data relevant to the analysis. The method generates an AI impact prediction component to simulate the effects of AI model outputs on a social network. The AI model outputs may be output data, information, decisions, predictions, etc.

The effect of the AI model outputs on the social network are shown with categorization of the actors of the social network based on the effect of the AI decision on the actors. The categories may be, for example, positive effect, negative effect, or neutral effect. The categories may be illustrated on a social knowledge graph of actors within the social network.

The simulation of effects of an AI output may identify the impact or unforeseen consequences of the AI output on the social network. This may identify actors in the social network who are impacted more than other actors. The simulation of the effect of AI outputs on the social network may be within a specific timeline and/or geographic location to visualize trends in social behavior. The simulation may be generalized across heterogeneous social networks.

Determining potential effects of AI outputs on a social network is an improvement in the technical field of computer engineering and artificial intelligence generally and more particularly in the technical field of predicting AI influence. The AI model output may relate to technical fields including: computer infrastructure provision, security infrastructure provision, industrial infrastructure provision, industrial control systems, medical treatment and diagnosis, supply chain, sustainable computing, development and operation of software (DevOps), etc.

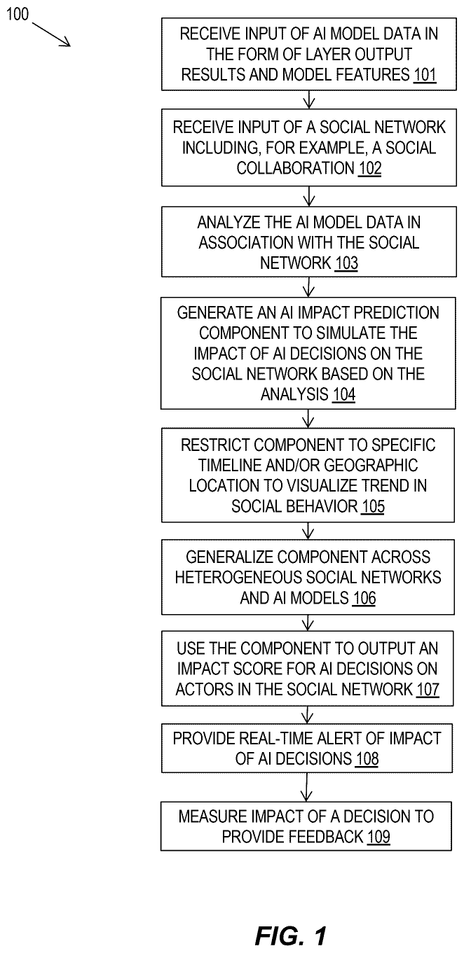

Referring to FIG. 1, a flow diagram 100 shows an example embodiment of the described method of determining potential effects of AI outputs on social networks.

The method may receive 101 AI model data in the form of AI model features and AI layer output results. The AI model features may be core features that have a high predictive quality (e.g. a high covariate score). The AI layer output results may include the probabilities of each model prediction at each layer. The AI layer output results provide the predictive stages of the model.

The method may also receive 102 input of data of a social network (including social networks in the form of social collaborations). The social network data may include names of the actors in a linked network including first level (direct) contacts, secondary or higher (indirect) contacts. The social network may be limited to a defined set of actors or to an entire organizational network, as required by the application.

Metadata relating to characteristics of each of the actors is obtained and stored for each node. For actors in the form of individuals, the metadata may include characteristics such as their demographic, education, qualifications, work role, work hierarchy, location, area of expertise, scope of work, etc. For actors in the form of groups of individuals, the metadata may be characteristics of or common to the group. The characteristics may be used to analyze different classes of actors, for example, actors with a common demographic, a common location, a common scope of work, etc. The metadata may be scraped or trolled from the social network information.

The method may analyze 103 the AI model data in association with the social network data including using a combination of exploratory data analysis, latent class analysis, and knowledge graph analysis. The analysis may probabilistically determine the predicted effect of an AI output on the actors of the social network based on their metadata.

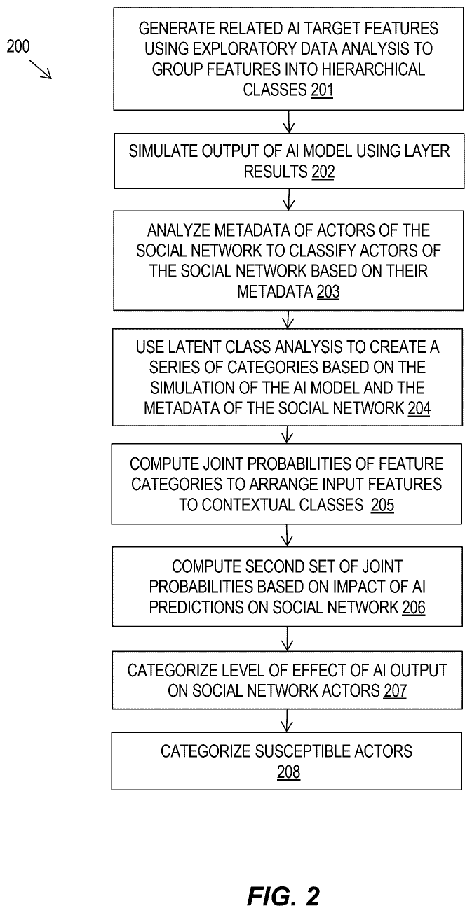

The analysis may be used to generate 104 an AI impact prediction component for the social network from the analysis as described further in the example embodiment of the method of FIG. 2. The analysis may take as inputs the AI model input features, the AI model prediction stages (layer outputs), and the social network with metadata. The AI impact prediction component simulates the effect of AI outputs on the social network. This impact may be the impact of the AI output based on a class of actors in the network based on their metadata.

The analysis may generate a series of effect categories for the actors within the network. The effect categories may be positive, negative, or neutral effects on the actors as a result of the AI output. An additional effect category of “susceptible” actors may be included where an actor has a high probability of response to AI outputs.

The AI impact prediction component may be restricted 105 to simulate the effect of AI decisions on a social network within a specific timeline and geographic location in order to visualize trends in social behavior.

The AI impact prediction component may be generalized 106 across heterogeneous social networks. The model may be generalized across tuples of social models and AI model types. AI model types may include Deep Learning Models, Survival Analysis Models, Time Series Models, etc. The social networks may include research networks, finance and operation networks, security networks, etc.

The AI impact prediction component may be used to output 107 an impact score for an AI output on classified actors of the social network. This may create a social knowledge graph of users within the social network.

The method may provide 108 real-time alerts of impacts of AI outputs. A real-time alert and mitigation may be provided on the impact of AI-generated outputs and policies on individuals within the social network.

A real-time unintended consequences “alert” system may be provided using machine learning to monitor and flag significant deviations in social network patterns caused by AI implementations, enabling pre-emptive measures to mitigate negative impacts. The method and system may alert the user and may propose to the user various alternatives for ameliorative processing. In addition, such feedback may be used to build adaptable models adjustable to evolving social and AI dynamics.

An application of the method may also be to ensure the data from one social platform is not skewing the outputs of AI decision making. A dashboard may be created to indicate the use of data from different combinations of social platform datasets as inputs to AI models, and there relative positive/negative outputs.

The method may extend to measuring 109 an impact on actors of the social network of an AI output after the actual output has occurred. This may be used as feedback for future iterations of learning for the AI impact prediction component.

Referring to FIG. 2, a flow diagram 200 shows an example embodiment of analysis of AI model data in association with a social network to generate an AI impact prediction component.

The method may generate 201 related target features using exploratory data analysis to analyze the AI model features of a dataset. Exploratory data analysis is used to determine the AI model features of a dataset and to perform covariance analysis to see how the features relate to each other and to determine the highest performing covariates. The outcome of this may be to group features into a hierarchical class and subclass set. The features are the target or outcome of the AI model.

The method may simulate 202 the output of the AI model by analyzing the prediction quality as the AI model moves through layers of the AI model training. This may store weighted values at successive epochs and layers. This may result in probabilistic scores that simulate how the AI model will predict. The layer output results may be exported as predicted weights of successive layers or epochs of the model.

The method may analyze 203 metadata of actors of the social network. This may use knowledge graph analysis to classify actors of the social network based on their metadata. The knowledge graph analysis may be used to analyze the metadata obtained for the actors of the network, for example, through scraping or trolling the social network.

The method may use 204 latent class analysis to create a series of categories based on the predictions of the AI model (based on the input features) and classifications of actors based on the social network metadata. In statistics, a latent class model (LCM) is a model for clustering multivariate discrete data. It assumes that the data arise from a mixture of discrete distributions, within each of which the variables are independent. It is called a latent class model because the class to which each data point belongs is unobserved or latent.

Using the layer results of the predictive model, the method takes these results by using latent class analysis, and determines a set of probabilities for each actor of the social network. For example, there may be a set of features that the AI model is predicting across a series of decisions. By looking at the outcomes of how an actor in a social network reacts or is affected (in terms of subsequent outcomes) to a decision, a joint probably distribution is created to measure the effect of each decision area.

The set of probabilities may include computing 205 a first set of joint probabilities of feature categories being used as part of the AI model output. Input features may be arranged to output explanations in the form of new “contextual classes” of the features. A second set of joint probabilities may be computed 206 based on the impact of the AI outputs on classes of actors of the social network.

The effect of the AI model output may be categorized 207 using level categories between positive and negative effects on the actors. The level categories may be positive, negative, or neutral. Such effects may include an adjustment in discourse cadence or sentiment by the actors, an amount of work in a collaborative network such as measured by Kloc code commits, etc.

The method may assess how likely an actor in a social network will be impacted. In order to determine how the actor will be impacted, the method may normalize the probability score across a separate function, such as a hyperbolic tangent function known as a tanh function, with a minimum value of −1 and a maximum value of 1. Positive normalized scores on the tanh scale equate to positive, and negative scores on the tanh scale equate to negative, and a score of 0 is deemed neutral.

The method may also categorize 208 “susceptible” actors whose probability distribution for AI model outputs indicate high level reactions to AI outputs. If a social network node is computed to have a high probability of a positive or negative reaction to an AI output, say for example multiple instances of above 0.75 probability of a reaction, this result may be used to infer a susceptible actor.

The method may create a social knowledge graph of actors or classes of actors within the social network with the categorized impact of the AI decision.

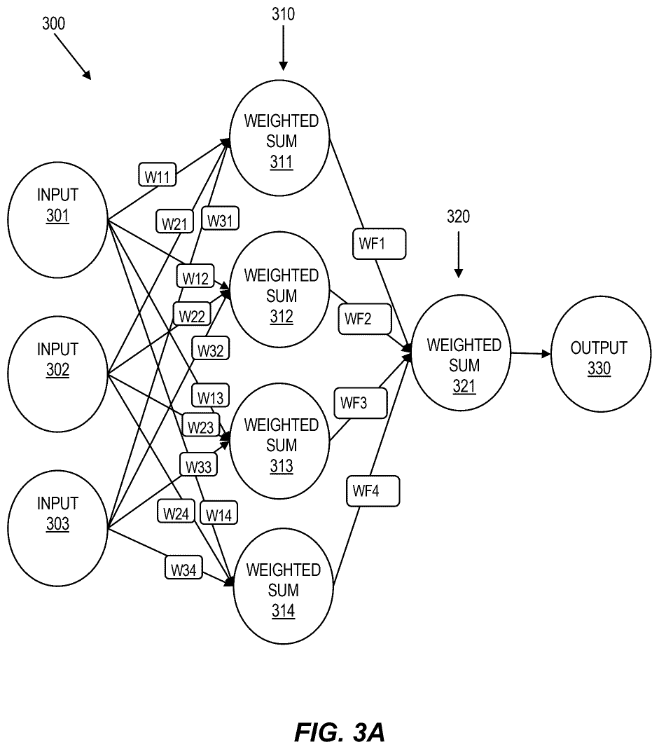

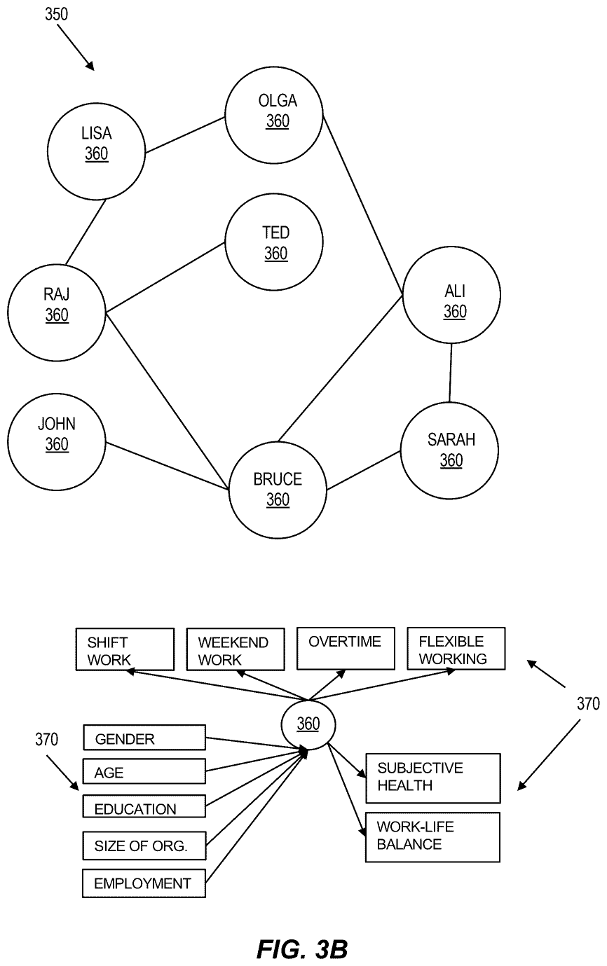

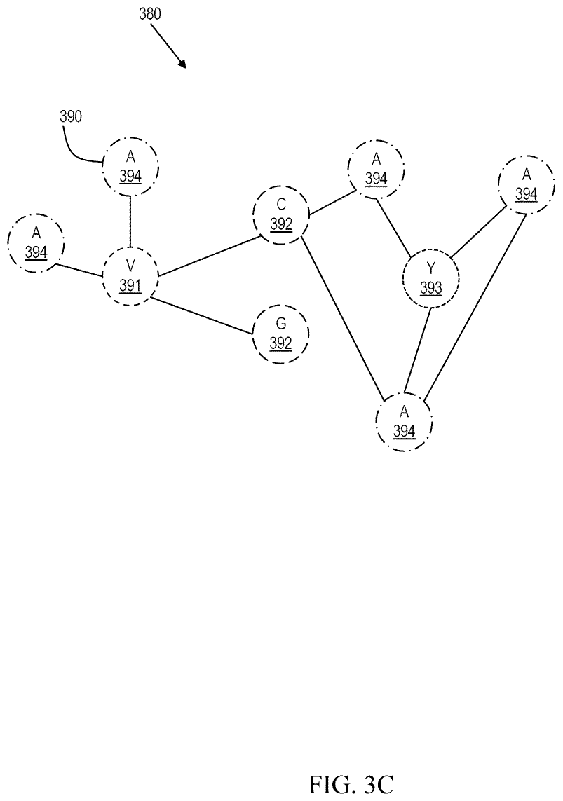

Referring to FIG. 3A, an AI model 300 may include feature inputs 301-303 and each layer 310, 320 of the AI model may have weighted scores 311-314, 321 or parameters of predictions which have losses minimized to provide an output 330. The AI model 300 makes prediction calculations at the layers 310, 320 of the AI model with weighted scores 311-314, 321 that are propagated through the AI model 300 to an output 330. The features and layer outputs are used in the analysis of the described method.

FIG. 3B shows an example social network 350 having multiple interconnected nodes 360 of actors in the social network 350. Each node 360 may have stored metadata 370 relating to characteristics of the actor of the node 360. The social network 350 and the metadata is used in the analysis of the described method.

FIG. 3C shows an example output of a latent class analysis that is provided as a categorized social network and presented as a knowledge graph 380. In the categorized social network nodes 390 are categorized has having a negative 391, positive 392, neutral 393 or susceptible 394 actor effects. Edges between nodes may have weightings relating to the strength of relationship between two actors in the social network. For example, this may be generated from a joint count of a number of messages exchanged between two actors.

An example may be described where the AI model is used for hardware planning prediction including different resource feature inputs one of which is the specification of GPUs. The first set of joint probabilities is the probability distribution of the occurrence of a feature being used as part of a prediction. In this use case of predicting a time to train an AI system, a feature could be number of GPUs, so having a probability density distribution that is used to determine how likely that feature will be used as part of model to predict AI system training time. A second series of joint probabilities is related to the probability that a particular social media class (e.g. Engineer, Manager or Executive) will be affected by the result of an AI prediction.

The following illustrates an example output of the analysis. The AI model output may be the resource planning prediction and the aim is to determine for two actor classes (say AI Engineer and Manager) how likely the impact will positive or negative Pr (1), Pr (2). In a more comprehensive example, four probabilities may be provided for the categories of Positive, Negative, Neutral and Susceptible. The rest of the output is an iteration through the remaining features to determine the probability.

```
LCA2 <− poLCA (f1, data=supplychain2015, nclass=2)
$planning
  Pr(1) Pr(2)
Class 1: 0.0261 0.9739
Class 2: 0.6644 0.3356
$tool_change
  Pr(1) Pr(2)
Class 1: 0.0360 0.9640
Class 2: 0.6249 0.3751
$licencing
  Pr(1) Pr(2)
Class 1: 0.1909 0.8910
Class 2: 0.7973 0,2027
Epoch1_Pef MAE = 0.2323, MSE, 0.4445
AIC=424.56, BIC=314.45
Epoch40_Perf MAE=0.1313, MSE, 0.3356
AIC=324.56, BIC=414.45
```

After the AI model output has occurred and its impact is made on the social network, the impact may be measured. This may be measured as the frequency of communication would be an indicator of positive, negative or neutral sentiment, such score can be mapped to a tanh function used for categorizing the effects on the actors.

The measurement of the frequency of communication may measure the number of outbound messages from a network contact and the duration time between messages (e.g. 10 posts an hour), measure the sentiment of the message content, and multiply the message rate by sentiment score. The output may be a normalized message rate*sentiment score on a scale of −1 to 1.

The output of the AI impact prediction component provides a series of probabilistic scores between 0 and 1 for each feature for each category of effect on the actors. The probabilistic results may be interpreted to determine features that have the strongest positive or negative effect on the social network actors.

Table 1 shows AI model features with probabilistic scores for each category of effect on the actors. Table 1 is a cross section of how a social media class like an AI engineer or manager is likely to be affected by an AI decision. The feature column is a feature used to make the AI decision, and the category is the type of impact, whether it be positive, negative, neutral, or susceptible. The number between 0 and 1 is how likely a social media class is affected.

TABLE 1

| Output | Neutral | Negative | Positive | Susceptible |
|---|---|---|---|---|
| Feature | Category 1 | Category 2 | Category 3 | Category 4 |
| Feature 1 | 0.25 | 0.25 | 0.25 | 0.25 |
| Feature 2 | 0.3 | 0.2 | 0.1 | 0.4 |
| Feature 3 | 0.1 | 0.7 | 0.1 | 0.1 |
| Feature 4 | 0.1 | 0.1 | 0.6 | 0.2 |
| Feature 5 | 0.3 | 0.3 | 0.1 | 0.2 |

A series of Goodness-of-fit (GoF) metrics may be computed to measure the explanation quality through each number of explanation classes. Goodness-of-fit may include, for example, Akaike Information Criterion (AIC), Bayesian Information Criterion (BIC), G-test (likelihood ratio test), Chi-Square (X²), Degrees of Freedom (Df), etc.

Table 2 shows the series of GoF metrics for 1 category, 2 categories, 3 categories, 4 categories.

The GoF are standard metrics to assess the quality of the predictions from the Latent Class analysis. When the analysis is run in multiple iterations, these GoF may be measured and recorded over time to assess if the quality of the prediction are getting “better or worse” over time.

TABLE 2

| GoF | 1 Category | 2 Categories | 3 Categories | 4 Categories |
|---|---|---|---|---|
| AIC | 59502.44 | 59119.43 | 58987.27 | 57987.27 |
| BIC | 59584.36 | 59246.03 | 59158.55 | 57158.55 |
| G-test | 557.3724 | 162.3576 | 18.19505 | 12.19505 |
| X² | 582.4475 | 180.5809 | 18.11012 | 12.11012 |
| Df | 20 | 14 | 8 | 4 |

There need to be robust forecasting tools capable of accurately modelling the potential consequences of AI systems within social networks. This gap in predictive capabilities means that organizations and societies often need to prepare for the cascading effects that AI-driven outputs and decisions can have.

This situation necessitates the development of advanced forecasting techniques and knowledge graph systems that can illuminate the intricate ways AI influences reshape social and collaborative environments. There is a complexity in such systems that requires the capture of intricate relationships and interactions within a knowledge graph to reflect the complex nature of social environments. There is also requirement to understand social dynamics, and ability to address ethical implications when AI reshapes social environments, ensuring fairness, transparency, and accountability.

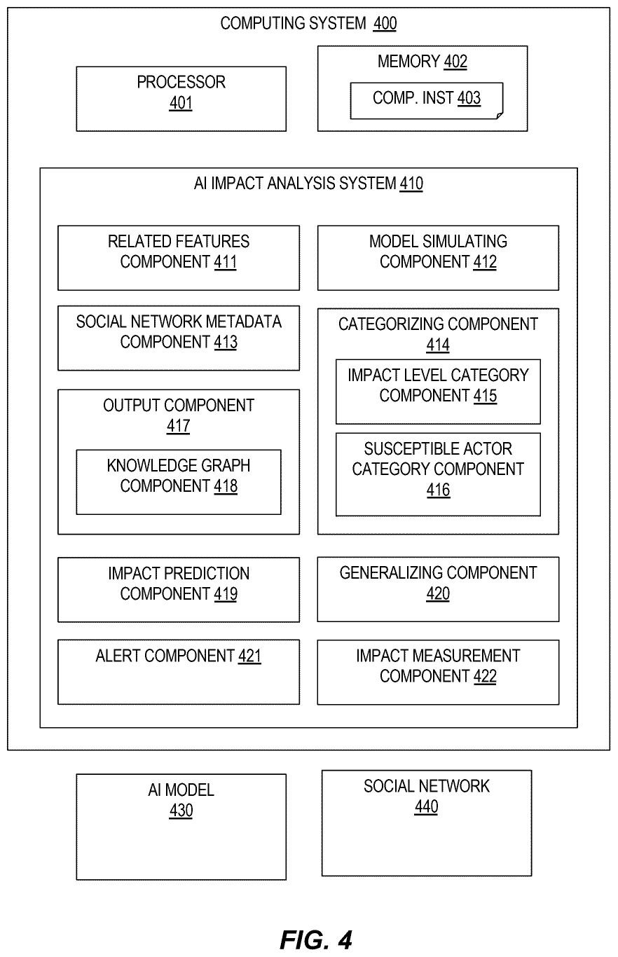

Referring to FIG. 4, a block diagram shows a computer system 400 in which the described method and system may be implemented.

The computer system 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

An AI impact analysis system 410 may be provided for determining effects of AI model 430 outputs on a social network 440. The AI impact analysis system 410 may include the following components. A related features component 411 may be provided for generating related target features of the AI model 340. A model simulating component 412 may be provided for simulating outputs of the artificial intelligence model using model layer results. A social network metadata component 413 may be provided for analyzing metadata of actors of the social network. The metadata may be obtained using social network mining tools.

A categorizing component 414 may be provided using latent class analysis of the related target features, the simulated outputs, and the metadata of the social network actors to categorize an effect of outputs of the artificial intelligence model on actors of the social network based on a joint probability distribution between classes of the metadata of the actor and context classes of the target features of the outputs. The categorizing component 414 may include an impact level category component 415 for categorizing positive, negative, and neutral categories of impact. The categorizing component 414 may include a susceptible actor category component 416 for using the latent class analysis to categorize actors with a high reaction probability for outputs as a susceptible category of actors.

An output component 417 may be provided to output categories of the effect of the outputs on the social network actors. The output component 417 may include a knowledge graph component 418 for outputting categories of the effect of the outputs on the social network actors in a knowledge graph with categories.

An impact prediction component 419 may be provided for applying the latent class analysis to categorize an effect on actors of the social network 440 of different outputs of the AI model 430.

A generalizing component 420 may be provided for generalizing the categories across heterogeneous social networks.

An alert component 421 may be provided for providing an alert of predicted consequences in a social network 440 relating to the AI model 430 outputs.

An impact measurement component 422 may be provide for measuring an impact of an AI model output after the output has occurred and using the measured impact as feedback for future iterations of learning of the impact prediction component 419.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 6, computing environment 600 contains an example of an environment for the execution of at least some of the computer code involved in performing the inventive methods, such as AI impact analysis system code 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

1. A computer-implemented method for determining effects of artificial intelligence model outputs on a social network, said method comprising:
generating related target features of an artificial intelligence model;
simulating outputs of the artificial intelligence model using model layer results;
analyzing metadata of actors of the social network;
using latent class analysis of the related target features, the simulated outputs, and the metadata of the social network actors to categorize predicted effects of outputs of the artificial intelligence model on actors of the social network based on a joint probability distribution between classes of the metadata of the actor and context classes of the target features of the outputs; and
outputting categories of the predicted effects of the outputs on the social network actors.

2. The method of claim 1, wherein categorizing predicted effects of an output uses level categories between positive and negative predicted effects on the actors.

3. The method of claim 1, further comprising:
using the latent class analysis to categorize actors as a susceptible category of actors, where actors have a high level of predicted effect based on a high probability of reaction to the outputs.

4. The method of claim 1, wherein generating related target features of the artificial intelligence model uses exploratory data analysis to group features into hierarchical classes.

5. The method of claim 1, wherein simulating an output of the artificial intelligence model using model layer results includes providing probabilistic scores to simulate how the model will predict the output.

6. The method of claim 1, wherein using the latent class analysis to categorize an effect on actors includes:
computing a first set of joint probabilities of feature classes being used as part of the model output; and
computing a second set of joint probabilities based on the impact of the model output on classes of the actors of the social network.

7. The method of claim 1, wherein outputting categories of the predicted effects of the outputs on the social network actors outputs the categories in a knowledge graph.

8. The method of claim 1, further comprising:
providing an impact prediction component using the latent class analysis to categorize predicted effects on actors of different outputs of the artificial intelligence model.

9. The method of claim 8, comprising:
measuring an impact of an artificial intelligence output after the output has occurred and using the measured impact as feedback for future iterations of learning of the impact prediction component.

10. The method of claim 1, further comprising:
restricting the analysis to predicted effects within a geographical location and/or specific timeline.

11. The method of claim 1, further comprising:
generalizing the categories across heterogeneous social networks.

12. The method of claim 1, further comprising:
providing an alert of consequences in a social network relating to the model outputs.

13. The method of claim 1, wherein the artificial intelligence model is for outputs of predictions in one or more fields of the group of: computer infrastructure provision, security infrastructure provision, industrial infrastructure provision, industrial control systems, medical treatment and diagnosis, supply chain, sustainable development, development and operation of computer software.

14. A computer system for determining effects of artificial intelligence model outputs on a social network comprising:
a processor, a memory device coupled to the processor, and a computer readable storage device coupled to the processor, wherein the storage device contains program code executable by the processor via the memory device to implement a method comprising:
generating related target features of an artificial intelligence model;
simulating outputs of the artificial intelligence model using model layer results;
analyzing metadata of actors of the social network;
using latent class analysis of the related target features, the simulated outputs, and the metadata of the social network actors to categorize a predicted effect of outputs of the artificial intelligence model on actors of the social network based on a joint probability distribution between classes of the metadata of the actor and context classes of the target features of the outputs; and
outputting categories of the predicted effect of the outputs on the social network actors.

15. The system of claim 14, wherein outputting categories of the predicted effects of the outputs on the social network actors, outputs the categories in a knowledge graph with positive, negative and neutral categories.

16. The system of claim 14, wherein the method includes using the latent class analysis to categorize actors with a high reaction probability for outputs as a susceptible category of actors.

17. The system of claim 14, further comprising:
an impact prediction component for applying the latent class analysis to categorize predicted effects on actors of different outputs of the artificial intelligence model.

18. The system of claim 17, wherein the method includes measuring an impact of an artificial intelligence output after the output has occurred and using the measured impact as feedback for future iterations of learning of the impact prediction component.

19. The system of claim 14, wherein the method includes providing an alert of consequences in a social network relating to the model outputs.

20. A computer program product, comprising:
a computer readable medium, and program instructions stored on the computer readable medium to perform operations comprising:
generating related target features of an artificial intelligence model;
simulating outputs of the artificial intelligence model using model layer results;
analyzing metadata of actors of the social network;
using latent class analysis of the related target features, the simulated outputs, and the metadata of the social network actors to categorize a predicted effect of outputs of the artificial intelligence model on actors of the social network based on a joint probability distribution between classes of the metadata of the actor and context classes of the target features of the outputs; and
outputting categories of the predicted effect of the outputs on the social network actors.
